(19) United States
(12) Patent Application Publication
(10) Pub. No.: US 2016/0249653 A1
(43) Pub. Date: Sep. 1, 2016

(54) Self-draining Package For Containing Pasta

(71) Applicant: Serdar M. SENAYDIN, Miami, FL (US)

(72) Inventor: Serdar M. SENAYDIN, Miami, FL (US)

(21) Appl. No.: 14/634,882

(22) Filed: Mar. 1, 2015

(51) Int. Cl. A23L 1/16; B65D 65/38; G01K 11/12; B65D 81/34

(52) U.S. Cl. CPC A23L 1/1613; G01K 11/12; B65D 81/34; B65D 65/38; A23V 2002/00; B65D 2581/3404

(57) ABSTRACT

A self-draining package for containing pasta and simplify the cooking process comprises a first removable sealing layer, a second removable sealing layer, tong or hook holes, removable strips, a perforation, side slots or holes, bottom slots or holes and a tight fitting lid. The self-draining package is environmentally friendly and can be reused for new cooking portion sizing and with its re-useable lid. The self-draining package is designed for both food service and consumer (retail) use. Single and multi-service portions are packed together or separated if necessary. The entire invention is 100% recyclable and follows strict hygiene regulations.

### FIELD OF THE INVENTION

The present invention relates to a self-draining package and, more particularly, to a self-draining package for containing pasta.

### BACKGROUND

A package containing pasta is usually provided with a fixed weight size. Wholesale-bulk and Retail (consumer) packs for different scales of consumption of pasta are often provided with paper or plastic packages with fixed serving sizes and shapes. There are many kinds of pasta and noodles. Each kind of pasta has its own size, shape, and boiling time (which is difficult to control). Current pasta packaging is not specially designed for each kind of pasta. Further, the materials used for current bulk and retail packaging are neither resistant to extreme heat nor cold, which results in a relatively short shelf time.

### SUMMARY OF THE INVENTION

The Self-draining package of this invention overcomes the issues stated above.

The object of the present invention is to provide a self-draining package containing pasta, which has variety of serving sizes and shapes. Retail (Consumer) or Bulk (Food-Service) packs with portion sizes range from 2.5 oz to 4 oz (approximately 70-120 gr) per serving. Several sizes and easily adaptable multi portion packs provide maximum flexibility for a single serve meal size for a single consumer or multiple serving packs for larger demand, which decreases the waste.

Another object of the present invention is to provide a self-draining package for containing pasta which is air tight sealed and heat and cold resistant. Thus, the shelf life of food can be extended. The raw material of self-draining package can be PPL (Polypropylene) which is heat and chill resistant for food packaging. Alternatively CPET (Crystalline Polyethylene Terephthalate) may be used for resisting extreme heat and cold.

Another object of the present invention is to provide a self-draining package comprising a color changing resin indicator with which food handlers can select serving options for ultimate taste and texture, like firm, al-dente, or soft cooked pasta and noodles.

### BRIEF DESCRIPTION OF THE DRAWINGS

FIG. 1A shows an elevation view of a self-draining package for containing pasta.

FIG. 1B shows a top view of a self-draining package for containing pasta.

FIG. 1C shows a side view of a self-draining package for containing pasta.

FIG. 2 shows a top view of three self-draining packages connected to each other.

FIG. 3A shows an elevation view of self-draining package 100 for containing short cut pasta and noodles.

FIG. 3B shows a side view of self-draining package 101 for containing short cut pasta and noodles.

FIG. 4A shows an elevation view of self-draining package 102 for containing even smaller cut pasta and noodles.

FIG. 4B shows a top view of self-draining package 103 for containing even smaller cut pasta and noodles.

### DETAILED DESCRIPTION OF THE INVENTION

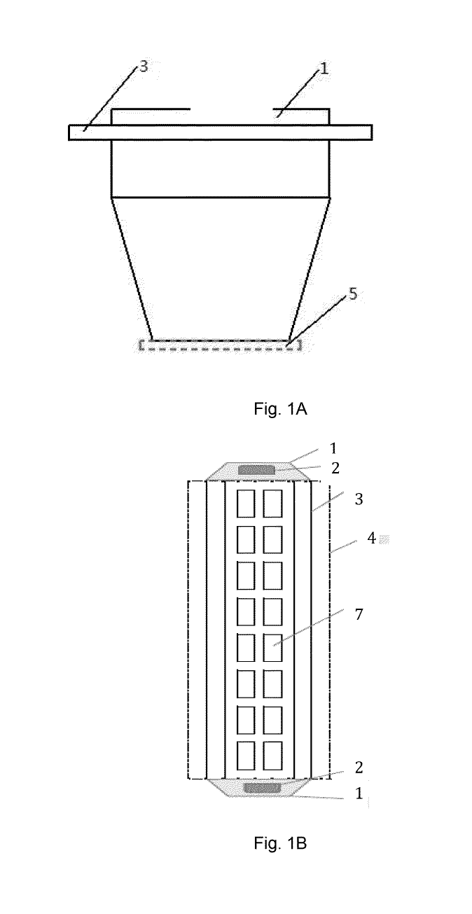

FIG. 1A-FIG. 1C shows one embodiment of the invention. In FIG. 1A-FIG. 1C, the self-draining package for containing pasta comprises first removable sealing layer 1, second removable sealing layer 5, tong or hook holes 2, removable strips 3, perforation 4, side slots or holes 6, bottom slots or holes 7 and tight fitting lid 8.

Self-draining package for containing pasta can be made of materials like soft and rigid PPL and CPET. For long cut pasta (like spaghetti, linguini fettuccini and lasagna) and rice and wheat noodle (like Japanese Udon), the single serving package size can be 275×25×25 mm (approximately 10.5″×1″×1″).

Removable strips 3 are located on the side walls of self-draining package and provide air sealing. Tight fitting lid 8 is located on top of self-draining package and provides additional air sealing. Tight fitting lid 8 is a cover for self-draining package.

Perforation 4 is located between a plurality of self-draining packages and provides connection for a plurality of self-draining packages. Thus a plurality of packages can be separated from each other with perforated easy hand cut off perforation 4 which allows any number of self-draining packages to be cooked one by one or as many as desired at once.

Side slots or holes 6 are located on the side walls of self-draining package. Bottom slots or holes 7 are located on the bottom of self-draining package. Side slots or holes 6 and bottom slots or holes 7 are formed by molded design or punching/drilling methods. The size and shape of side slots or holes 6 and bottom slots or holes 7 depend on the shape and cut style of the pasta and noodles.

Side slots or holes 6 and bottom slots or holes 7 are covered by first removable sealing layer 1 and second removable sealing layer 5. First removable sealing layer 1 and second removable sealing layer 5 are made from materials like PPL and CPET. First removable sealing layer 1 and second removable sealing layer 5 provide air sealing for self-draining package and can be removed easily with a simple, pulling apart way by hand.

When a user removes first removable sealing layer 1 or second removable sealing layer 5, side slots or holes 6 and bottom slots or holes 7 are exposed fully. User inserts self-draining package with pasta or noodles into a container full of boiling water.

Upon completion of the boiling water treatment or preparation process, self-draining package with pasta or noodles is removed from the boiling water and drained easily with side slots or holes 6 and bottom slots or holes 7. Tong or hook holes 2 are located on both ends of the self-draining package. Tong or hook holes 2 are built-in handles which can be handled by a simple pair of tongs or curved end picks.

Self-draining package is designed for long shelf life, using a highly hygienic and easy packaging according to the strict industry standards. A single self-draining package, or a plurality of self-draining packages are used with only a small volume of fresh boiling water. The design of the self-draining package also allows consumers to enjoy freshly prepared pasta and noodles anytime, anyplace, again with only a small volume of boiling water, further reducing waste.

Self-draining package can be used by a single consumer or mass production food service kitchens. Moreover, as explained above, the same sealed packed pasta and or noodles can be an easy nutritious meal replacement where there is no kitchen available.

The original base of self-draining package maybe used for just the pasta and noodles, where the side of self-draining package contains water for boiling and sauces and spices for a complete meal experience.

The self-draining package is customized for long cut pasta items like spaghetti, linguine and lasagna and long noodles. Self-draining package is about 275 mm long, 25×25 mm wide and of varying heights for linguine and fettuccine or lasagna specifications with larger and longer side slots or holes 6 and bottom slots or holes 7 of self-draining package as shown in the attached representative drawings. Self-draining packages of the same size can be recycled or reused.

In another embodiment, self-draining package for containing pasta further comprises color changing resin indicator 9. Color changing resin indicator 9 can be placed on first removable sealing layer 1 or second removable sealing layer 5. Color changing resin indicator 9 changes colors at different temperatures which vary with cooking time. Food handlers can select options for ultimate taste and texture, like al-dente (firm/soft) cooked pasta and noodles with color changing resin indicator 9.

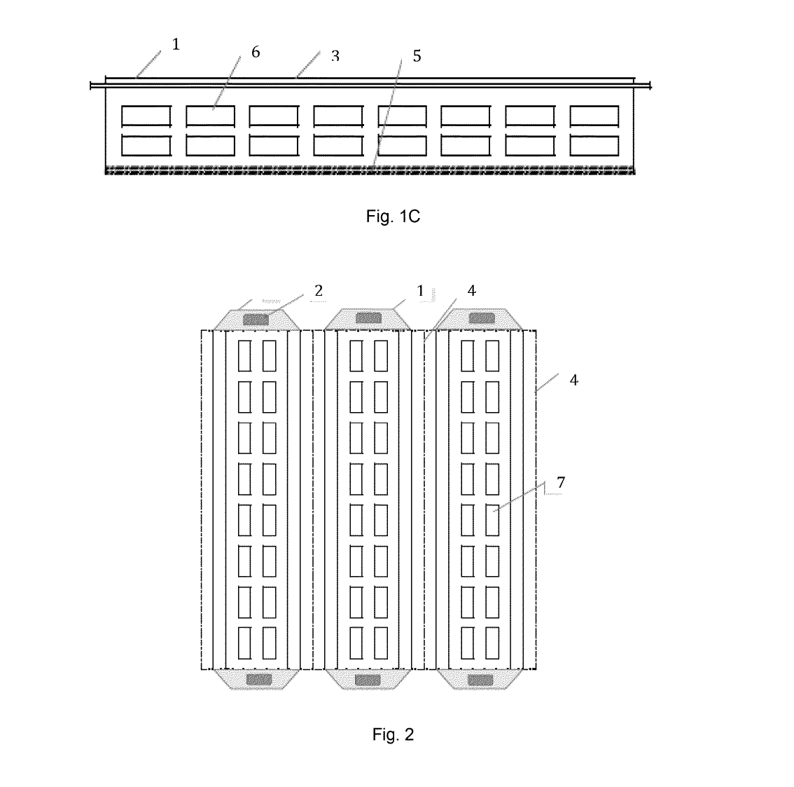

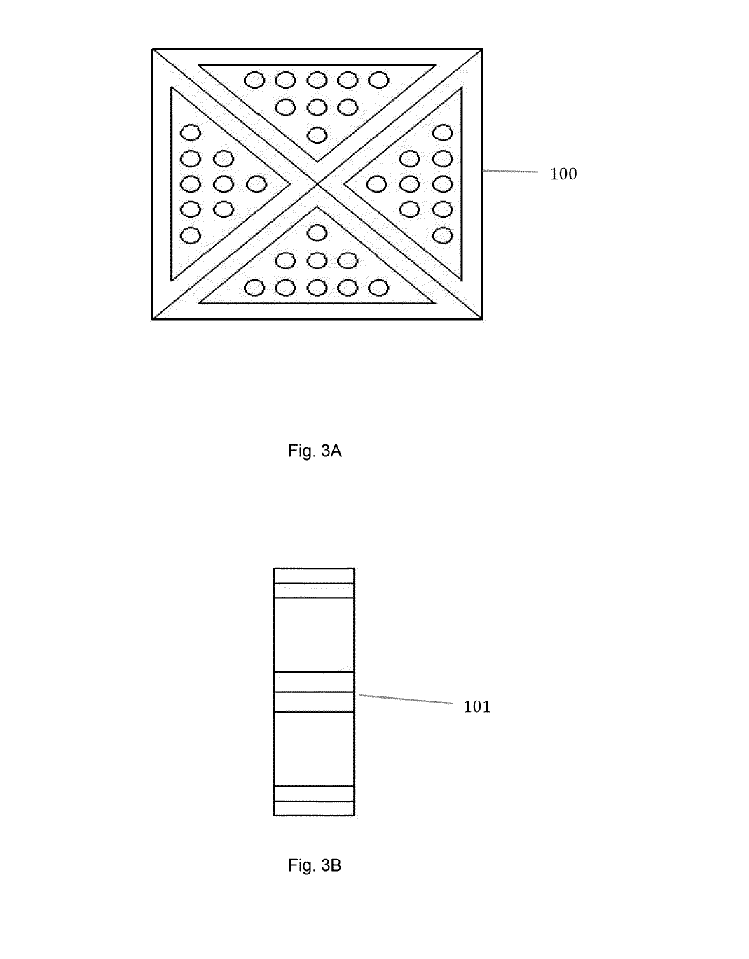

FIG. 2 shows a top view of three self-draining packages connecting with each other. FIG. 3A-FIG. 3B shows a self-draining package for smaller cut pasta items, like Elbows, Penne Fusilli or the like. A variety of package designs of geometric shapes are also available with smaller drain holes. General dimensions like the length, width and height of the self-draining package are only relevant to the kind of pasta and noodles in self-draining package and their respective specifications.

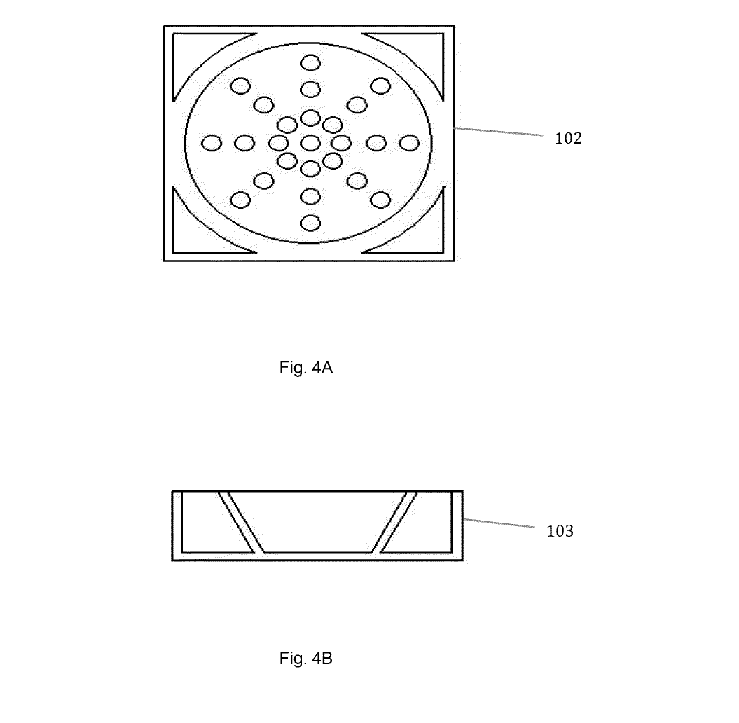

FIG. 4A-FIG. 4B shows a self-draining package for even smaller cut or grains like pasta including orzo, bulgur and couscous, which can be drained within the similar packages with even smaller drain holes.

Short cut pasta (like penne, elbows or fusilli) and granular or very small cut (bulgur, couscous and orzo) versions of pasta products will be packed in various geometrically shaped self-draining package. Pasta and noodle containing in self-draining package can be simultaneously heated with side packs with desired sauces like, Marinara, Alfredo or Pesto with pasta and noodles served possibly with dashi, soy sauce (shôyu), mirin and scallions as condiments.

1. A self-draining package for containing pasta, comprising:
a first removable sealing layer;
a second removable sealing layer;
a plurality of tong or hook holes;
a plurality of removable strips;
a perforation;
a plurality of side slots or holes;
a plurality of bottom slots or holes; and
a tight fitting lid;
wherein the plurality of removable strips are located on the side walls of the self-draining package and provide air sealing;
wherein the tight fitting lid is located on top of the self-draining package and provides air sealing;
wherein the perforation is located between a plurality of self-draining packages and provides connections for the plurality of self-draining packages;
wherein the plurality of side slots or holes are located on the side walls of the self-draining package and the plurality of bottom slots or holes are located on the bottom of the self-draining package;
wherein the plurality of side slots or holes and the plurality of bottom slots or holes are covered by the first removable sealing layer and the second removable sealing layer;
wherein the plurality of tong or hook holes are located on both ends of the self-draining package;
wherein the plurality of removable strips are located on the side walls of the self-draining package and provide air sealing.

2. The self-draining package for containing pasta of claim 1, wherein the self-draining package for containing pasta is made from materials like soft and rigid PPL and CPET.

3. The self-draining package for containing pasta of claim 1, wherein the plurality of side slots and holes and the plurality of bottom slots or holes are formed by a molded design or punching/drilling methods;
wherein the size and shape of the plurality of side slots or holes and the plurality of bottom slots or holes depend on the shape and cut style of the pasta and noodles.

4. The self-draining package for containing pasta of claim 1, wherein the first removable sealing layer and the second removable sealing layer are made from materials like PPL and CPET;
Wherein the first removable sealing layer and the second removable sealing layer provide air sealing for self-draining package and can be removed easily with a simple, pulling apart way by hand.

5. The self-draining package for containing pasta of claim 1, wherein the plurality of tong or hook holes are built-in handles which can be handled by a simple pair of tongs or curved end picks.

6. A self-draining package for containing pasta, comprising:
a first removable sealing layer;
a second removable sealing layer;
a plurality of tong or hook holes;
a plurality of removable strips;
a perforation;
a plurality of side slots or holes;
a plurality of bottom slots or holes;
a tight fitting lid; and
a color changing resin indicator;
wherein the plurality of removable strips are located on the side walls of the self-draining package and provide air sealing;
wherein the tight fitting lid is located on top of the self-draining package and provides air sealing;
wherein the perforation is located between a plurality of self-draining packages and provides connections for the plurality of self-draining packages;
wherein the plurality of side slots or holes are located on the side walls of the self-draining package and the plurality of bottom slots or holes are located on the bottom of the self-draining package;
wherein the plurality of side slots or holes and the plurality of bottom slots or holes are covered by the first removable sealing layer and the second removable sealing layer;
wherein the plurality of tong or hook holes are located on both ends of the self-draining package;
wherein the plurality of removable strips are located on the side walls of the self-draining package and provide air sealing;
wherein the color changing resin indicator is placed on the first removable sealing layer or the second removable sealing layer.

7. The self-draining package for containing pasta of claim 6, wherein the self-draining package for containing pasta is made from materials like soft and rigid PPL and CPET.

8. The self-draining package for containing pasta of claim 6, wherein the plurality of side slots and holes and the plurality of bottom slots or holes are formed by molded design or punching/drilling methods;
wherein the size and shape of the plurality of side slots or holes and the plurality of bottom slots or holes depend on the shape and cut style of the pasta and noodles.

9. The self-draining package for containing pasta of claim 6, wherein the first removable sealing layer and the second removable sealing layer are made from materials like PPL and CPET;
wherein the first removable sealing layer and the second removable sealing layer provide air sealing for self-draining package and can be removed easily with a simple, pulling apart way by hand.

10. The self-draining package for containing pasta of claim 6, wherein the plurality of tong or hook holes are built-in handles which can be handled by a simple pair of tongs or curved end picks.

11. The self-draining package for containing pasta of claim 6, wherein the color changing resin indicator changes colors at different temperatures.
wherein food handlers can select options for ultimate taste and texture, like al-dente (firm/soft) cooked pasta and noodles with the color changing resin indicator.
